(19) United States
(12) Patent Application Publication
(10) Pub. No.: US 2013/0086983 A1
(43) Pub. Date: Apr. 11, 2013

(54) FUEL SENSOR

(71) Applicant: Masato Ueno, Takahama-city (JP)

(72) Inventor: Masato Ueno, Takahama-city (JP)

(73) Assignee: DENSO CORPORATION, Kariya-city (JP)

(21) Appl. No.: 13/603,490

(22) Filed: Sep. 5, 2012

(30) Foreign Application Priority Data
Oct. 11, 2011 (JP) 2011-223863

(51) Int. Cl. G01F 1/68

(52) U.S. Cl. 73/204.11

(57) ABSTRACT

A tubular external electrode has an inner passage configured to flow fuel therethrough. A bottomed tubular internal electrode is at a predetermined distance from an inner wall of the external electrode. A temperature sensor is located in the internal electrode. A detection unit detects a property of fuel according to both a signal from the temperature sensor and an electrical property of fuel in the inner passage. The temperature sensor has a center located between the center axis of the internal electrode and an inner wall of the internal electrode located on an upstream side relative to fuel flow in the inner passage.

### CROSS REFERENCE TO RELATED APPLICATION

This application is based on reference Japanese Patent Application No. 2011-223863 filed on Oct. 11, 2011, the disclosure of which is incorporated herein by reference.

### TECHNICAL FIELD

The present disclosure relates to a fuel sensor configured to detect a property of fuel.

### BACKGROUND

Conventionally, a known fuel sensor for detecting a property of fuel, such as an ethanol concentration in the fuel, is equipped in a fueling system, which is for supplying fuel to an internal combustion engine. In such a configuration, the ethanol concentration detected with the fuel sensor is transmitted to an electronic control unit (ECU) for the internal combustion engine. Thus, the ECU controls a fuel injection quantity, a fuel injection timing, and the like, according to the ethanol concentration. Such a configuration enables to enhance drivability of a vehicle and to restrain pollution of exhaust gas.

For example, a patent document 1 discloses a fuel sensor equipped with a tubular external electrode located in a fuel passage and equipped with a bottomed tubular internal electrode located in the external electrode. In the patent document 1, the external electrode has a first communication hole and a second communication hole, each communicating a space inside of the inner wall and a space outside of the outer wall in the radial direction. Fuel in the fuel passage flows through the first communication hole into the external electrode, and the fuel is exhausted through the second communication hole. The thermistor located in the internal electrode has a terminal including a bent resilient portion, which biases the thermistor to cause the thermistor to be in contact with the bottom portion of the internal electrode. In the configuration of the patent document 1, heat of fuel flowing in the external electrode is directly transferred through the bottom portion of the internal electrode into the thermistor. It is noted that, the dielectric constant of fuel changes with variation in the temperature of fuel. In consideration of this, the fuel sensor detects the ethanol concentration of fuel according to the temperature of fuel detected with the thermistor and according to the capacitance between the electrodes (external electrode and internal electrode) caused by fuel as the dielectric medium therebetween.

For example, a patent document 2 discloses a fuel sensor equipped with a bottomed tubular internal electrode having a bottom portion from which an accommodating portion is projected in the axial direction to accommodate a thermistor therein. In the patent document 2, the outer diameter of the accommodating portion is smaller than the outer diameter of the tubular portion of the internal electrode. With configuration of the patent document 2, the accommodating portion has a small thermal capacity thereby to reduce a time period to transfer heat of fuel in a fuel passage through the accommodating portion into the thermistor. Further, in the patent document 2, the fuel sensor includes a metallic thermal conduction member connected to both a terminal of the thermistor and the internal electrode. Thus, heat of fuel in the fuel passage is transferred from the internal electrode through the thermal conduction member and the terminal into the thermistor. In the configuration of the patent document 2, the time period to transfer heat of fuel in the fuel passage into the thermistor can be reduced, since the thermal conductivity of a metallic material is significantly high.
[Patent Document 1] Publication of Japanese unexamined patent application 2010-223830 corresponding to U.S. Pat. No. 8,159,232
[Patent Document 2] Publication of Japanese unexamined patent application 2011-107070

Herein, it is noted that, in the patent document 1, in a case where the flow rate of fuel passing around the bottom portion of the internal electrode is small, it is conceivable that the response time delay of the thermistor may be large, in response to change in the temperature of fuel flowing through the fuel passage. Accordingly, in the patent document 1, it is conceivable that the fuel sensor may cause a large detection error in detection of the ethanol concentration.

On the other hand, in the patent document 2, the accommodating portion of the internal electrode does not function as an electrode. Accordingly, in the patent document 2, the inter-electrode capacitance may become small to cause a large influence of a noise to the detection of the ethanol concentration to result in causing a large detection error in the detection of the ethanol concentration. In addition, according to the patent document 2, provision of the additional thermal conduction member may increase the number of components to result in increase in the manufacturing cost of the fuel sensor.

### SUMMARY

It is an object of the present disclosure to provide a fuel sensor configured to enhance its detection accuracy.

According to an aspect of the present disclosure, a fuel sensor comprises an external electrode substantially in a tubular shape and having an inner passage configured to flow fuel therethrough. The fuel sensor further comprises an internal electrode substantially in a bottomed tubular shape and being at a predetermined distance from an inner wall of the external electrode, the internal electrode having a center axis substantially perpendicular to a direction of fuel flow in the inner passage. The fuel sensor further comprises a temperature sensor located in the internal electrode. The fuel sensor further comprises a detection unit configured to detect a property of fuel according to an output signal from the temperature sensor and an electrical property of fuel flowing through the inner passage. The temperature sensor has a center located between the center axis of the internal electrode and an inner wall of the internal electrode, the inner wall being located on an upstream side relative to fuel flow in the inner passage.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a fuel sensor according to the first embodiment of the present disclosure;

FIG. 2 is a sectional view taken along a line II-II in FIG. 1;

FIG. 3A is a graph showing an analysis result of a response time delay of the fuel sensor relative to change in the temperature of fuel, FIG. 3B is a graph showing values of maximum temperature error relative to change in the position of a temperature sensor in the fuel sensor, and FIG. 3C is a view showing the position of the temperature sensor in the fuel sensor;

FIG. 4 is a sectional view showing a fuel sensor according to the second embodiment of the present disclosure;

FIG. 5 is a sectional view showing a fuel sensor according to the third embodiment of the present disclosure; and

FIG. 6 is a sectional view showing a fuel sensor according to the fourth embodiment of the present disclosure.

### DETAILED DESCRIPTION

As follows, multiple embodiments of the present disclosure will be described with reference to drawings.

### First Embodiment

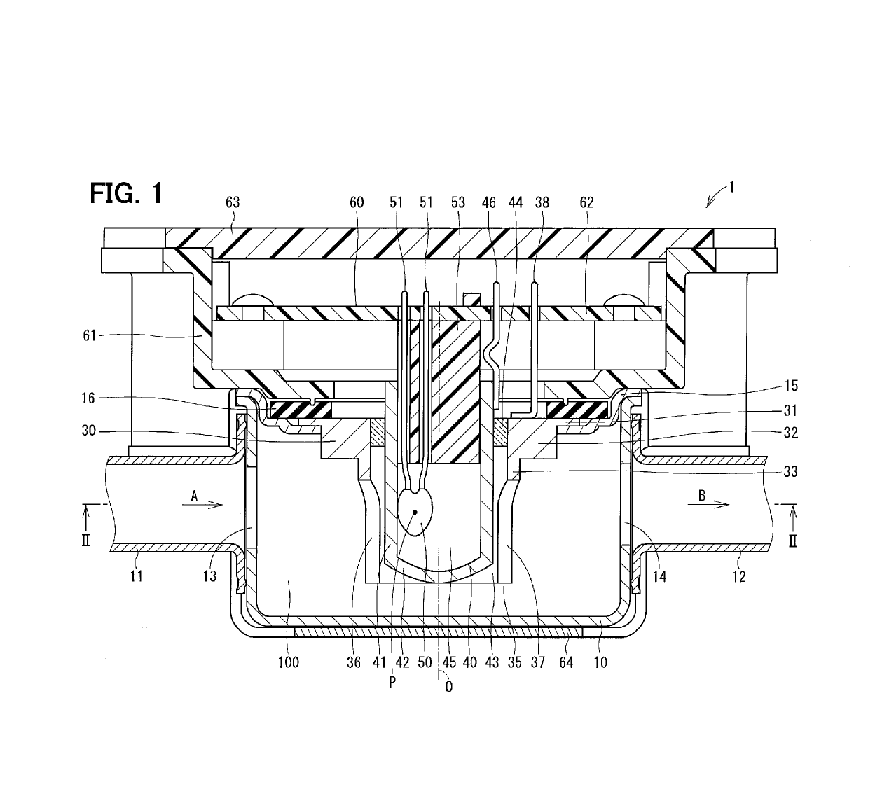

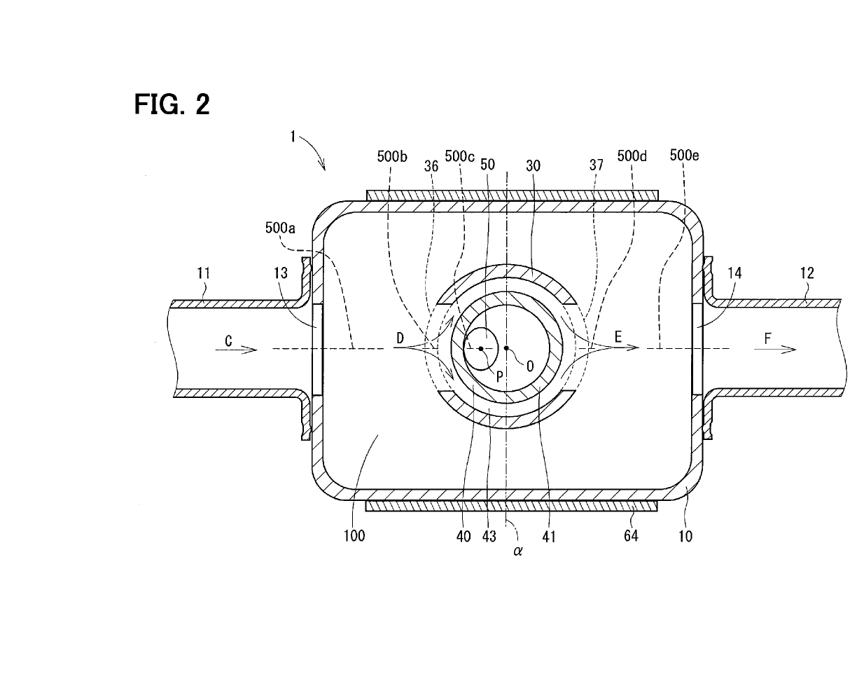

FIGS. 1 and 2 show a fuel pump according to the first embodiment of the present disclosure. The fuel sensor 1 of the present embodiment is equipped to a fueling system, which connects a fuel tank of a vehicle with a fuel injection device, and configured to detect a concentration of ethanol contained in fuel. The ethanol concentration detected with the fuel sensor 1 is transmitted to an ECU for an internal combustion engine. The ECU controls a fuel injection quantity, a fuel injection timing, an ignition timing, and the like, according to the ethanol concentration. The present configuration controls an air-fuel ratio of the internal combustion engine appropriately thereby to promote drivability of the vehicle. In addition, the present configuration further enables reduction in a toxic substance contacted in exhaust gas.

As shown in FIG. 1, the fuel sensor 1 includes a fuel case 10, an external electrode 30, an internal electrode 40, a thermistor 50 as a temperature sensor, a detection circuit 60 as a detection unit, and the like. The fuel case 10 is formed of a metallic material such as stainless steel and is in a bottomed tubular shape. The fuel case 10 has a fuel passage 100 therein. The fuel case 10 has one outer wall in the radial direction, and the one outer wall is connected with a feed pipe 11 for supplying fuel. The fuel case 10 has the other outer wall in the radial direction, and the other outer wall is connected with an exhaust pipe 12 for exhausting fuel. The feed pipe 11 and the exhaust pipe 12 are affixed to the outer wall of the fuel case 10 by welding or the like. The fuel case 10 has a supply opening 13 at the outer wall, to which the feed pipe 11 is connected, and has an exhaust opening 14 at the outer wall, to which the exhaust pipe 12 is connected. The fuel case 10 has an opening on the opposite side from the bottom, and the opening is covered with a lid member 15. In FIG. 1, an arrow A and an arrow B represent the direction of fuel flow.

The external electrode 30 is formed of a metallic material, such as stainless steel, and is in a tubular shape. The external electrode 30 is located in the fuel passage 100 of the fuel case 10. The external electrode 30 has a center axis, which is substantially perpendicular to the direction of fuel flow in the fuel passage 100, and has an end 35 having an opening located in the bottom of the fuel case 10. The external electrode 30 includes a flange 31, a thick portion 32, and an electrode body 33. The flange 31 is in an annular shape and extended radially outward from one end of the external electrode 30 in the axial direction. The thick portion 32 is located on the lower side of the flange 31. The electrode body 33 is located on the lower side of the thick portion 32. The flange 31 is retained by the lid member 15. The thick portion 32 is projected from the flange 31 toward the fuel passage 100.

The external electrode 30 has a first communication hole 36 and a second communication hole 37, which communicates inside of the inner wall of the electrode body 33 with the outside of the outer wall of the electrode body 33 in the radial direction. The first communication hole 36 is located on the upstream side relative to fuel flow in the fuel passage 100. The second communication hole 37 is located on the downstream side relative to fuel flow in the fuel passage 100. Each of the first communication hole 36 and the second communication hole 37 is substantially in a U shape and is opened on the bottom side of the fuel case 10.

The internal electrode 40 is formed of a metallic material, such as stainless steel, and is in a tubular shape having a closed-end. The internal electrode 40 includes a tubular portion 41, which is substantially in a tubular shape, and a bottom portion 42, which plugs one end of the tubular portion 41. The internal electrode 40 is located at the radially inside of the external electrode 30 and is at a predetermined distance from the inner wall of the external electrode 30. The internal electrode 40 is substantially coaxial with the external electrode 30. In the present configuration, the internal electrode 40 and the external electrode 30 define an inner passage 43, through which fuel flows, therebetween. The internal electrode 40 has a center axis O, which is substantially perpendicular to the direction of fuel flow in the inner passage 43.

An insulative material 44, which formed of glass, is located between the thick portion 32 of the external electrode 30 and the internal electrode 40. The insulative material 44 hermetically secures the internal electrode 40 with the external electrode 30 and electrically insulates the internal electrode 40 from the external electrode 30. The insulative material 44 may be an O-ring formed of a resin material.

As shown by an arrow C in FIG. 2, fuel is supplied from the feed pipe 11 to pass through the supply opening 13 and to flow into the fuel passage 100 inside of the fuel case 10. As shown by an arrow D, the fuel further flows from the first communication hole 36 of the external electrode 30 into the inner passage 43 and further flows through a gap between the internal electrode 40 and the external electrode 30. Thus, as shown by an arrow E, the fuel flows out from the opening in the end 35 of the external electrode 30 or from the second communication hole 37 into the fuel passage 100. Furthermore, as shown by the arrow F, the fuel flows from the fuel passage 100 through the exhaust opening 14, and the fuel is finally exhausted from the exhaust pipe 12.

The thermistor 50 is located in the internal electrode 40. The thermistor 50 has a center P located between an inner wall of the internal electrode 40, which is located upstream in the inner passage 43 relative to the fuel flow, and a center axis O of the internal electrode 40. More specifically, referring to FIG. 2, the center P of the thermistor 50 is located on the upstream side from a virtual plane α relative to the fuel flow in the inner passage 43. The virtual plane α is substantially perpendicular to the fuel flow in the inner passage 43 and includes the center axis O of the internal electrode 40. It is noted that, the inner wall of the internal electrode 40, which is located on the upstream side in the inner passage 43 relative to the fuel flow, changes in temperature most quickly, in response to change in temperature of fuel flowing through the inner passage 43. In consideration of this, the center P of the thermistor 50 is located on the upstream side from the virtual plane α.

The thermistor 50 is in contact with the tubular portion 41 of the internal electrode 40. In addition, the thermistor 50 is located on a straight line, which is shown by segmented dotted lines 500a, 500b, 500c, 500d, 500e in FIG. 2, connecting the feed pipe 11, the first communication hole 36, the second communication hole 37, and the exhaust pipe 12. Therefore, heat of fuel flowing through the inner passage 43 is directly transferred through the internal electrode 40 into the thermistor 50. The thermistor 50 changes its electrical resistance in response to change in its temperature. Thus, the temperature of fuel flowing through the inner passage 43 can be detected according to an output signal from the thermistor 50.

Referring to FIG. 1, the thermistor 50 has a terminal 51 supported by a support member 53, which is formed of a resin material, and is connected to a circuit board 62 by soldering or welding. The support member 53 is retained by the circuit board 62 and is inserted in the internal electrode 40. The inner wall of the internal electrode 40 and the support member 53 form a space 45 therebetween. The space 45 may be charged with a heat transfer material such as a heat dissipation grease.

An annular elastic member 16 is equipped to the upper side of the lid member 15. A circuit case 61 is formed on the upper side of the elastic member 16. The elastic member 16 restricts fuel from leaking through the gap between the lid member 15 and the circuit case 61.

The circuit case 61 is formed of, for example, a resin material and accommodates the circuit board 62. The circuit board 62 is equipped with the detection circuit 60, which is configured to detect an electrical property of fuel flowing through the inner passage 43. The detection circuit 60 is connected with a terminal 38, which is connected to the external electrode 30, a terminal 46, which is connected to the internal electrode 40, and the terminal 51 of the thermistor 50. The circuit case 61 has an opening surrounded with a plate-shaped cover 63. The cover 63 restricts fluid such as water from permeating into the circuit case 61 from the outside of the circuit case 61.

A bracket 64 supports the outer periphery of the fuel case 10. The bracket 64 is affixed to the circuit case 61 with a fastener such as a screw (not shown). With the present configuration, the fuel case 10 is affixed to the circuit case 61.

The detection circuit 60 is configured to cause the external electrode 30 and the internal electrode 40 to charge electricity therebetween and discharge electricity therefrom. Thus, the detection circuit 60 detects the capacitance between the electrodes, which therebetween form the inner passage 43 through which fuel flows as a dielectric medium. As follows, one example of a detection method will be described. The detection circuit 60 has a memory device storing, as a data map, an analytical curve, which represents the relation between the ethanol concentration of fuel and the capacitance between the electrodes. The relation between the ethanol concentration and the capacitance (inter-electrode capacitance) varies according to the temperature of fuel. Therefore, the detection circuit 60 stores multiple analytical curves. The detection circuit 60 specifies one of the analytical curves according to the temperature of fuel detected with the thermistor 50. The detection circuit 60 further detects the ethanol concentration in fuel from the inter-electrode capacitance with reference to the specified one of the analytical curves.

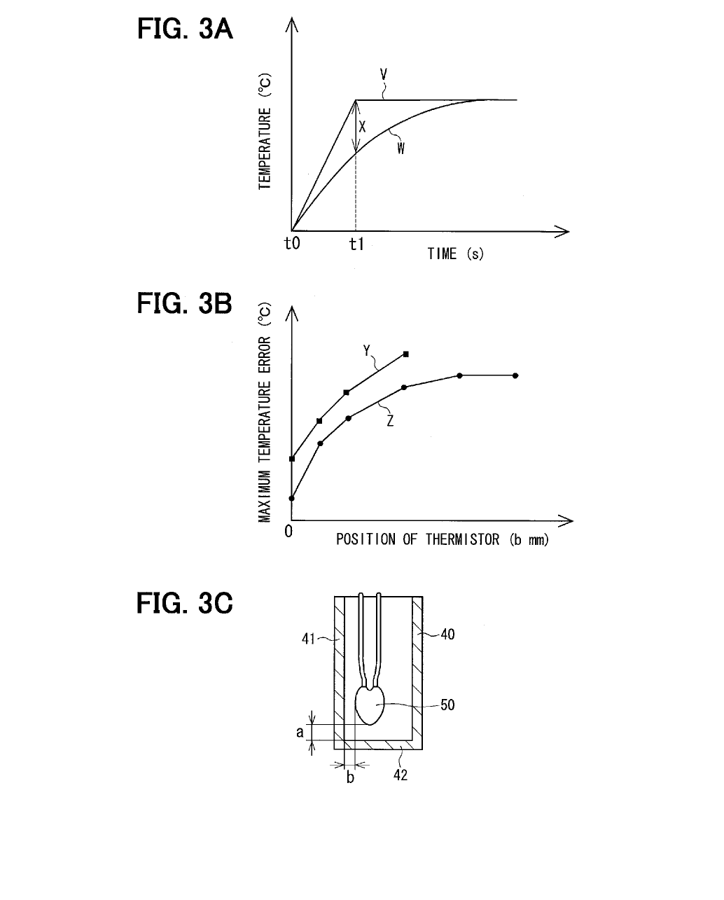

FIG. 3A shows an analysis result showing a response time delay of the output signal from the thermistor 50 relative to change in the temperature of fuel in the inner passage 43. It is noted that, fuel flow is not taken into consideration in the analysis. In general, as shown by the solid line W in FIG. 3A, the signal sent from the thermistor 50 changes when, as shown by the solid line V, the temperature of fuel in the inner passage 43 changes from the time t0 to the time t1. The arrow X shows a maximum temperature error at this time. FIG. 3B shows values of the maximum temperature error, which are plotted as the position of the thermistor 50 is changed inside the internal electrode 40. FIG. 3C shows the position of the thermistor 50. In FIG. 3C, the thermistor 50 is at a distance of a (mm) from the bottom portion 42 of the internal electrode 40. Further, the thermistor 50 is at a distance of b (mm) from the tubular portion 41 of the internal electrode 40.

In FIG. 3B, the solid line Y represents the values of the maximum temperature error, which are plotted as the distance b (mm) is increased gradually from 0 (mm), in the case where the distance a (mm) is a predetermined distance greater than 0 (mm). The solid line Z represents the values of the maximum temperature error, which are plotted as the distance b (mm) is increased gradually from 0 (mm), in the case where the distance a (mm) is 0 (mm). Both the solid line Y and the solid line Z represent that the maximum temperature error is the smallest on condition that the distance b=0 (mm), and the maximum temperature error increases as the distance b (mm) increases. In addition, the solid line Z represents the values of the maximum temperature error, which are smaller than the values represented by the solid line Y. That is, the values of the maximum temperature error are smaller on condition that the distance a=0 (mm), compared with the values of the maximum temperature error on condition that the distance a>0 (mm).

According to the analysis result, it is conceivable that the maximum temperature error of the signal sent from the thermistor 50 becomes smaller, as the thermistor 50 is closer to the tubular portion 41 of the internal electrode 40. In addition, it is conceivable that the maximum temperature error of the signal sent from the thermistor 50 becomes further smaller, when the thermistor 50 is in contact with the bottom portion 42 of the internal electrode 40.

The present embodiment produces the following operation effects.

(1) In the present embodiment, the center P of the thermistor 50 is located between the inner wall of the internal electrode 40, which is located on the upstream side in the inner passage 43 relative to the fuel flow, and the center axis O of the internal electrode 40. In addition, the thermistor 50 is in contact with the tubular portion 41. The portion of the internal electrode 40, which is located on the upstream side in the inner passage 43 relative to the fuel flow, changes in temperature most quickly, in response to change in the temperature of fuel flowing through the inner passage 43. In the present configuration, the heat of fuel in the inner passage 43 directly transfers from the inner wall of the tubular portion 41 of the internal electrode 40 to the thermistor 50. Therefore, the response time delay of the output signal, which is transmitted from the thermistor 50 and caused in response to change in the temperature of fuel flowing through the inner passage 43, can be reduced. Thus, the present configuration enables the detection circuit 60 to specify correctly the analytical curve, which corresponds to change in the temperature of fuel flowing through the inner passage 43. Thus, the inter-electrode capacitance can be detected with high accuracy. Consequently, the fuel sensor 1 can be enhanced in its detection accuracy.

(2) In the present embodiment, the thermistor 50 is located on the straight line 500a, 500b, 500c, 500d, 500e connecting the feed pipe 11, the first communication hole 36, the second communication hole 37, and the exhaust pipe 12, thereamong. The straight line 500a, 500b, 500c, 500d, 500e corresponds to the main flow of fuel with the largest flow rate. That is, in the present configuration, the thermistor 50 is located at the position where the flow rate of fuel is the largest in the inner passage 43. Thus, the response time delay of the output signal from the thermistor 50 can be reduced.

### Second Embodiment

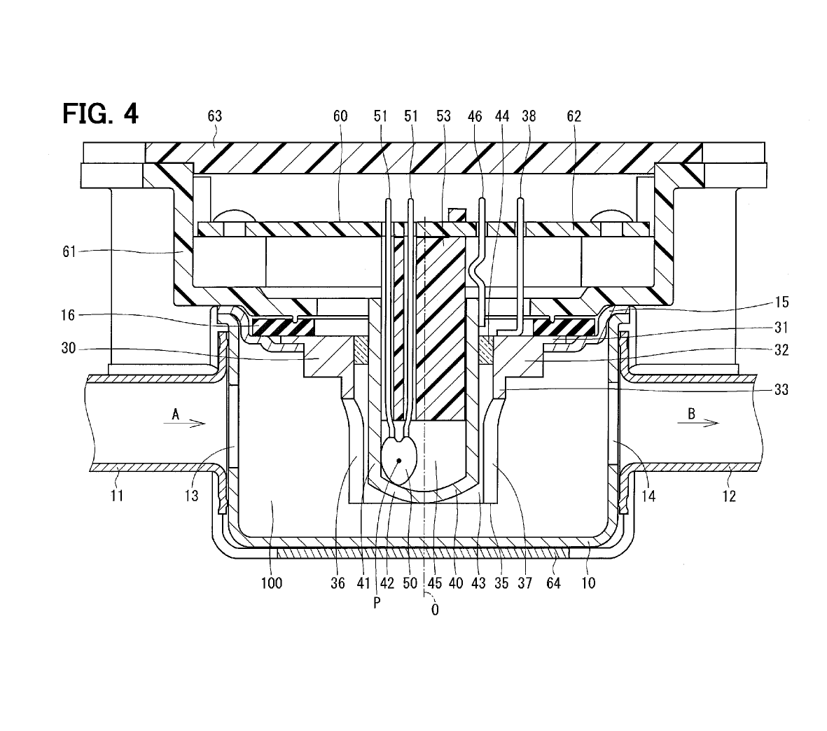

FIG. 4 shows a fuel sensor according to the second embodiment of the present disclosure. In the following embodiments, an element substantially the same as that of the above-described first embodiment will be denoted by the same reference numeral and description thereof will be omitted.

In the second embodiment, the thermistor 50 is in contact with both the tubular portion 41 and the bottom portion 42 of the internal electrode 40. With the present configuration, heat of fuel flowing through the inner passage 43 is directly transferred through both the tubular portion 41 and the bottom portion 42 of the internal electrode 40 into the thermistor 50. Therefore, the contact portions between the thermistor 50 and the internal electrode 40 are increased, compared with the configuration of the first embodiment. Thus, the present configuration reduces the time period, which is needed for heat transfer from fuel in the inner passage 43 to the thermistor 50 through the internal electrode 40. Therefore, the response time delay of the output signal from the thermistor 50 can be reduced. Thus, the detection circuit 60 is enabled to detect the inter-electrode capacitance correctly in response to change in the temperature of fuel flowing through the inner passage 43.

### Third Embodiment

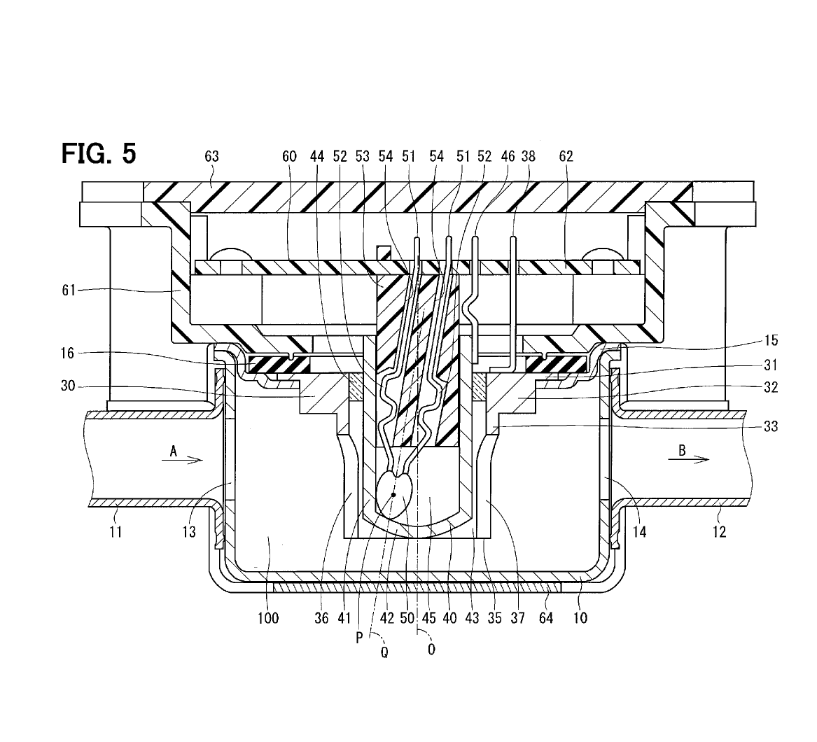

FIG. 5 shows a fuel sensor according to the third embodiment of the present disclosure. In the third embodiment, an axis Q of the thermistor 50 is inclined relative to the center axis O of the internal electrode 40. Furthermore, the terminal 51 of the thermistor 50 has bent portions 52, which are bent wirings and are located between the thermistor 50 and the circuit board 62. In a state before the thermistor 50 is equipped inside the internal electrode 40, the distance between the thermistor 50 and the circuit board 62 is greater than the distance between the bottom portion 42 of the internal electrode 40 and the circuit board 62. Therefore, when the thermistor 50 is equipped inside the internal electrode 40, the bent portions 52 function as biasing units to bias the thermistor 50 onto both the tubular portion 41 and the bottom portion 42 of the internal electrode 40.

In addition, the support member 53 has holes 54, which are inclined relative to the center-axis O of the internal electrode 40. The terminal 51 of the thermistor 50 is inserted to each of the holes 54. With the present configuration, the support member 53 guides the terminal 51 of the thermistor 50, such that each bent portion 52 biases the thermistor 50 onto the tubular portion 41 and the bottom portion 42 of the internal electrode 40. Therefore, the thermistor 50 is biased from the bent portions 52, each equipped in the terminal 51, toward both the tubular portion 41 and the bottom portion 42 of the internal electrode 40 thereby being steadily in contact with the inner wall of the internal electrode 40.

According to the present third embodiment, the thermistor 50 and the internal electrode 40 can be restricted from causing a gap therebetween due to, for example, a dimensional tolerance of the thermistor 50. Therefore, the response time delay of the output signal from the thermistor 50 can be reduced. Thus, the detection circuit 60 is enabled to detect the inter-electrode capacitance correctly in response to change in the temperature of fuel flowing through the inner passage 43. Furthermore, according to the present third embodiment, the bent portion 52 is configured to absorb a stress working on the thermistor 50 thereby to protect the thermistor 50 from an excessive stress working thereon.

### Fourth Embodiment

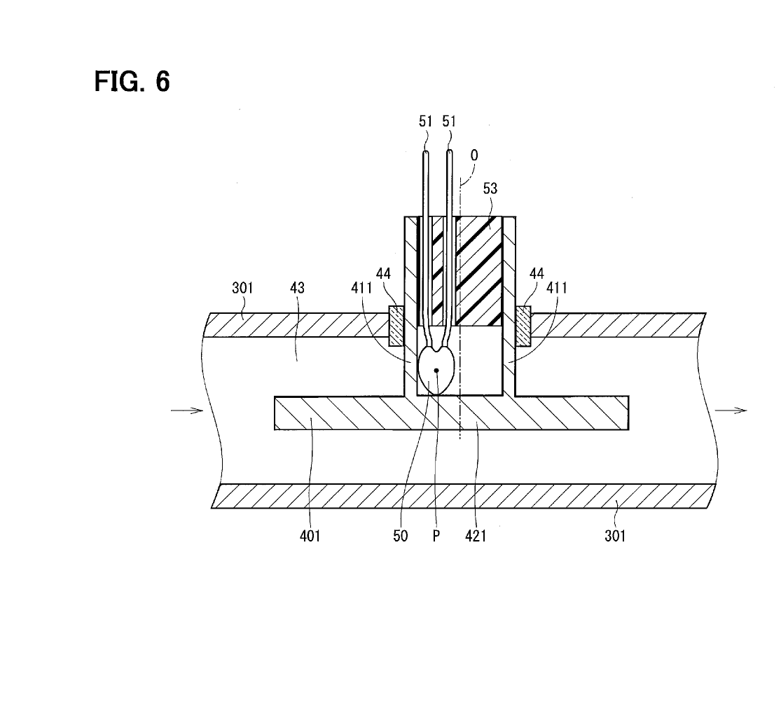

FIG. 6 shows a fuel sensor according to the fourth embodiment of the present disclosure. In the fourth embodiment, fuel flows along the axial direction of an external electrode 301, which is in a tubular shape. An internal electrode 401 is located in the external electrode 301. The internal electrode 401 includes a shaft portion 421 and a tubular portion 411. The shaft portion 421 is substantially in parallel with the direction of fuel flow in the inner passage 43. The tubular portion 411 is in a tubular shape and is extended from the shaft portion 421 outward in the radial direction of the external electrode 301. The internal electrode 401 has a center axis O, which is substantially perpendicular to the direction of fuel flow in the inner passage 43. The insulative material 44 is located between the tubular portion 411 of the internal electrode 401 and the external electrode 301.

The thermistor 50 is located in the tubular portion 411 of the internal electrode 401. The terminals 51 of the thermistor 50 are connected to a circuit board (not shown). The center P of the thermistor 50 is located between the inner wall of the tubular portion 411, which is located on the upstream side in the inner passage 43 relative to the fuel flow, and the center axis O of the tubular portion 411. The thermistor 50 is in contact with the inner wall of the tubular portion 411 of the internal electrode 401 and is further in contact with the shaft portion 421. In the present embodiment, the shaft portion 421 of the internal electrode 401, which is in contact with the thermistor 50, is equivalent to the bottom portion, similarly to the bottom portion of the internal electrode 401 in the first to third embodiments.

With the present configuration, heat of fuel flowing through the inner passage 43 is directly transferred through both the tubular portion 411 of the internal electrode 401 and the shaft portion 421 into the thermistor 50. The configuration according to the fourth embodiment also produces the same operation effect as those of the above-described first to third embodiments.

### Other Embodiment

In the above-described embodiments, the fuel sensor is configured to detect the ethanol concentration in fuel according to the electrical property between the electrodes. Alternatively, the sensor of the present disclosure may be configured to detect other various properties, such as a deterioration state of fuel due to, for example, oxidization, according to the electrical property between electrodes.

The fuel sensor according to the above-described embodiments is configured to detect the inter-electrode capacitance thereby to detect the property of fuel and the state of fuel according to the dielectric constant of fuel. Alternatively, the fuel sensor according to the present disclosure may be configured to detect the resistance between electrodes thereby to detect the property of fuel and the state of fuel according to the conductivity of fuel.

Summarizing the above embodiments, the fuel sensor may include the external electrode, the internal electrode, the temperature sensor, and the detection unit. The external electrode may be substantially in the tubular shape and may have the inner passage configured to flow fuel therethrough. The internal electrode may be substantially in the bottomed tubular shape and may be at the predetermined distance from the inner wall of the external electrode. The internal electrode may have the center axis substantially perpendicular to the direction of fuel flow in the inner passage. The temperature sensor may be located in the internal electrode. The detection unit may be configured to detect a property of fuel according to both the output signal from the temperature sensor and the electrical property of fuel flowing through the inner passage. The temperature sensor may have the center located between the inner wall of the internal electrode, which is located on the upstream side relative to the fuel flow in the inner passage, and the center axis of the internal electrode.

The flow rate of fuel passing through the inner passage is largest around the outer periphery of the internal electrode on the upstream side of the fuel flow. Therefore, the portion of the internal electrode, which is located on the upstream side relative to the fuel flow, changes in temperature most quickly, in response to change in the temperature of fuel flowing through the inner passage. The temperature sensor may be located between the inner wall of the internal electrode in the upstream portion and the center axis of the internal electrode thereby to reduce the response time delay of the temperature sensor. With the present configuration, the detection unit is enabled to detect correctly the electrical property of fuel, in response to change in the temperature of fuel flowing through the inner passage. Consequently, detection accuracy of the fuel sensor can be enhanced.

The internal electrode may include the tubular portion, which is substantially in the tubular shape, and the bottom portion, which plugs one end of the tubular portion. In this case, the temperature sensor may be in contact with the tubular portion of the internal electrode. With the present configuration, temperature of fuel in the inner passage is conducted to the temperature sensor directly through the tubular portion of the internal electrode. Therefore, the response time delay of the temperature sensor can be reduced.

The temperature sensor may be in contact with both the tubular portion of the internal electrode and the bottom portion of the internal electrode. With the present configuration, the contact portions between the temperature sensor and the internal electrode can be increased. Therefore, the time period for conducting the temperature of fuel in the inner passage to the temperature sensor through the internal electrode can be reduced. Thus, the response time delay of the temperature sensor in response to change in the temperature of fuel in the inner passage can be reduced.

The fuel sensor may further include the fuel case, the feed pipe, and the exhaust pipe. In this case, the fuel case may form the fuel passage therein, and the external electrode, the internal electrode, and the temperature sensor may be located in the fuel passage. The feed pipe may be connected to the fuel case and may be configured supply fuel into the fuel passage of the fuel case. The exhaust pipe may be connected to the fuel case and may be configured exhaust fuel from the fuel passage of the fuel case. The external electrode may have the first communication hole and the second communication hole configured to communicate the inner wall and the outer wall of the external electrode in the radial direction. Further, the external electrode may have the center axis substantially perpendicular to the direction of fuel flow in the fuel passage. Further, the temperature sensor may be located on the straight line, which connects the feed pipe, the first communication hole, the second communication hole, and the exhaust pipe. In the present configuration, fuel flows from the feed pipe into the fuel passage, and the fuel further flows through the first communication hole of the external electrode into the inner passage. The fuel further flows from the second communication hole through the fuel passage into the exhaust pipe. In the present configuration, the temperature sensor is located at the position where the flow rate of fuel is the largest in the inner passage. Thus, the response time delay of the temperature sensor can be reduced.

The fuel sensor may further include the biasing unit and the support member. In this case, the biasing unit may be located in the internal electrode and may be located on the opposite side from the bottom portion of the internal electrode when being viewed from the temperature sensor. The support member may guide the biasing unit such that the biasing unit biases the temperature sensor toward the inner wall of the internal electrode. In the present configuration, the biasing unit is guided by the support member to cause the temperature sensor to be steadily in contact with the inner wall of the internal electrode. Thus, the response time delay of the temperature sensor can be reduced.

The above structures of the embodiments can be combined as appropriate. It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel sensor comprising:
an external electrode substantially in a tubular shape and having an inner passage configured to flow fuel therethrough;
an internal electrode substantially in a bottomed tubular shape and being at a predetermined distance from an inner wall of the external electrode, the internal electrode having a center axis substantially perpendicular to a direction of fuel flow in the inner passage;
a temperature sensor located in the internal electrode; and
a detection unit configured to detect a property of fuel according to
an output signal from the temperature sensor and
an electrical property of fuel flowing through the inner passage,
wherein
the temperature sensor has a center located between the center axis of the internal electrode and an inner wall of the internal electrode, the inner wall being located on an upstream side relative to fuel flow in the inner passage.

2. The fuel sensor according to claim 1, wherein
the internal electrode includes
a tubular portion, which is substantially in a tubular shape, and
a bottom portion, which plugs one end of the tubular portion, and
the temperature sensor is in contact with the tubular portion of the internal electrode.

3. The fuel sensor according to claim 2, wherein the temperature sensor is in contact with both the tubular portion and the bottom portion.

4. The fuel sensor according to claim 1, further comprising:
a fuel case defining a fuel passage, the fuel case accommodating the external electrode, the internal electrode, and the temperature sensor in the fuel passage;
a feed pipe connected with the fuel case and configured to supply fuel into the fuel passage of the fuel case; and
an exhaust pipe connected with the fuel case and configured to exhaust fuel from the fuel passage of the fuel case, wherein
the external electrode has a first communication hole and a second communication hole configured to communicate a space inside of an inner wall of the external electrode with a space outside of an outer wall of the external electrode in the radial direction,
the external electrode has a center axis substantially perpendicular to a direction of fuel flow in the fuel passage, and
the temperature sensor is located on a straight line, which connects the feed pipe, the first communication hole, the second communication hole, and the exhaust pipe.

5. The fuel sensor according to claim 1, further comprising:
a biasing unit located in the internal electrode and located on an opposite side from the bottom portion of the internal electrode when being viewed from the temperature sensor; and
a support member configured to guide the biasing unit to cause the biasing unit to bias the temperature sensor to the inner wall of the internal electrode.
